(19) United States
(12) Patent Application Publication
(10) Pub. No.: US 2013/0180682 A1
(43) Pub. Date: Jul. 18, 2013

(54) VEHICLE HEAT RELEASE STRUCTURE

(71) Applicant: Yasunori IMADA, Yokkaichi-city (JP)

(72) Inventor: Yasunori IMADA, Yokkaichi-city (JP)

(73) Assignee: SUMITOMO WIRING SYSTEMS, LTD., Mie (JP)

(21) Appl. No.: 13/610,186

(22) Filed: Sep. 11, 2012

(30) Foreign Application Priority Data
Jan. 12, 2012 (JP) 2012-003945

(51) Int. Cl. B60H 1/26; B60H 1/22

(52) U.S. Cl. 165/41; 454/75; 454/70

(57) ABSTRACT

A wire harness is threaded from a cabin exterior to a cabin interior. A heat releasing hose is provided by integrally mounting a main portion in the wire harness by taping and the like. A first end portion of the heat releasing hose branches from the wire harness within an engine compartment and is connected to a second terminus of an auxiliary hose provided to a lateral surface of a housing unit so as to enable heated air in a vicinity of a heat generator to flow therethrough. A second end portion of the heat releasing hose is positioned in a location in the cabin interior where air can be expelled.

### CROSS-REFERENCE TO RELATED APPLICATIONS

The present application claims priority under 35 U.S.C. §119 of Japanese Application No. 2012-003945, filed on Jan. 12, 2012, the disclosure of which is expressly incorporated by reference herein in its entirety.

### BACKGROUND OF THE INVENTION

1. Field of the Invention

The present invention relates to a heat release structure for a vehicle supplying a heat releasing effect to a predetermined heat generator housed within a housing unit such as an ECU (Electronic Control Unit), a junction block (J/B), or the like provided in a predetermined cabin exterior region, such as a vehicle's engine compartment.

2. Description of Related Art

Housing units (blocks) such as a junction block or an ECU are generally provided to an engine compartment (vehicle exterior region in an automobile). Ordinarily, these housing units are electrically connected to an exterior via a wire harness.

In addition to ambient temperature within the engine compartment (cabin exterior region), these housing units include on an interior thereof components constituting heat generators generating heat by electric conductivity. Many components constituting heat generators require strategies for releasing heat. Hereafter, first through third heat release strategies, performed as conventional heat release strategies, are described.

(First Heat Release Strategy)

FIG. 7 is an explanatory diagram showing a first conventional heat release strategy for a junction block 41. As shown in the figure, in the junction block 41 components (such as a relay, a fuse, a circuit breaker, or the like, which are not shown in the drawing) which may constitute heat generators are placed within a housing case 50. The above-noted components are housed by providing a lid 51 thereabove. In addition, a heat releasing fin 52 is provided running from an interior of the housing case 50 to an exterior on a lateral surface. Through contact with outside air, the heat releasing fin 52 supplies a heat release strategy for heat generated by the interior components. An example of a heat release structure with this kind of heat releasing fin 52 (heat sink) is a casing with a built-in circuit board, as disclosed by Related Art 1.

(Second Heat Release Strategy)

FIG. 8 is an explanatory diagram showing a second conventional heat release strategy for a junction block 42. As shown in the figure, in the junction block 42 components (such as a relay, a fuse, a circuit breaker, or the like, which are not shown in the drawing) which may constitute heat generators are placed within a housing case 70. The above-noted components are housed by providing a lid 71 thereabove. Moreover, a panel connector 72 constituting a heat transfer sheet is provided running from an interior of the housing case 70 to an exterior on a lateral surface. A heat releasing panel 73 having a step portion 73a on an end side is provided on an exterior exposed surface of the panel connector 72. The two surfaces of the step portion 73a form a contact surface area with the outside air, and thus the heat releasing panel 73 carries out a strategy for releasing heat generated by the interior components via the heat releasing panel 73 and the panel connector 72.

(Third Heat Release Strategy)

FIG. 9 is an explanatory diagram showing a third conventional heat release strategy for an ECU 43. As shown in the figure, in the ECU 43 a heat generating block 64 including computer chips, for example, is placed within a housing case 60. The heat generating block 64 is housed by providing a lid 61 thereabove. Moreover, a cooling pipe 62 and a cooling pipe 63 having comparatively large diameters are provided on one lateral surface and another lateral surface of the housing case 60. Air from a separately-provided, dedicated cooling fan (not depicted) is forced in through the cooling pipe 62 and then forced out through the cooling pipe 63. By performing an air cooling process of this kind by drawing heat, a heat release strategy is performed for heat generated by the heat generating block 64. In addition, a cooling fan is provided, for example, to the engine compartment (cabin exterior region).

Related Art 1: Japanese Patent Laid-open Publication No. 2007-109993

### SUMMARY OF THE INVENTION

However, the first and second conventional heat releasing strategies described above achieve a heat releasing effect through contact with outside air by a dedicated heat releasing component (the heat releasing fin 52, the heat releasing panel 73, and the like), and are therefore problematic in that costs increase accordingly.

Moreover, the above-described heat-releasing components must be made large enough to absolutely ensure a contact surface area necessary for heat release and, in addition, must avoid interfering with other exterior components when put in place. Accordingly, the first and second heat releasing strategies are problematic as regards the size and placement of heat releasing components, in that limitations on vehicle mounting are significant.

The third conventional heat release strategy described above requires that a dedicated cooling fan and the cooling pipes 62 and 63 having comparatively large diameters be provided as dedicated heat releasing components. The third conventional heat release strategy is therefore problematic in that a configuration of the heat release structure becomes complicated and costs more.

The present invention is conceived to resolve the above issues and has as an object to obtain, with a simple configuration and without inviting limitations on vehicle mounting, a heat release structure for a vehicle capable of a heat release strategy for a heat generator.

The heat release structure for a vehicle of a first aspect of the present invention is a heat release structure for a vehicle for a predetermined heat generator provided in a predetermined cabin exterior region of the vehicle. The heat release structure includes a wire harness positioned so as to run from the predetermined cabin exterior region to a cabin interior and a heat releasing hose having a first end portion, a main portion, and a second end portion in which the main portion is integrally mounted in the wire harness. The first end portion of the heat releasing hose is positioned within the predetermined cabin exterior region and the second end portion of the heat releasing hose is positioned in the cabin interior. Thereby, when a predetermined condition for the vehicle is satisfied, heated air in a vicinity of the predetermined heat generator can be taken in by the first end portion, pass through the main portion, and then be expelled to the cabin interior by the second end portion.

A second aspect is the heat release structure for the vehicle of the first aspect, where the predetermined condition includes an air pressure differential arising between the cabin interior and the predetermined vehicle exterior region due to air pressure inside the cabin becoming lower than that of the predetermined vehicle exterior region.

A third aspect is the heat release structure for the vehicle of the first aspect, where the cabin interior includes an air conditioned region having a predetermined air conditioner. The predetermined air conditioner has a cabin interior air intake ability, taking in air of the cabin interior via an intake hose while active. The second end portion can be connected so as to flow into a middle portion of the intake hose. The predetermined condition includes a case where the predetermined air conditioner is active.

A fourth aspect is the heat release structure for the vehicle of the first aspect, where the predetermined heat generator includes a heat generator housed within a housing unit. The heat release structure for the vehicle further includes an auxiliary hose in which a first terminus is positioned adjacent to the predetermined heat generator inside the housing unit and a second terminus is positioned outside the housing unit. The first end portion is connected to the second terminus of the auxiliary hose such that heated air can flow therethrough.

A fifth aspect is the heat release structure for the vehicle of the fourth aspect, where the wire harness includes at least one bundle of electric wires. The heat release structure for the vehicle further includes a wire harness connection provided at a foremost end of the at least one bundle of electric wires and a unit connection provided to the housing unit and capable of linking with the wire harness connection. The unit connection includes an opening capable of expelling heated air from the predetermined heat generator. The wire harness connection includes a heat releasing hose connection terminal capable of connecting to the first end portion of the heat releasing hose. When the unit connection and the wire harness connection are linked, the first end portion connected to the wire harness connection allows air within the housing unit to flow through the opening.

A sixth aspect is the heat release structure for the vehicle of the fourth aspect, where the housing unit includes an ECU.

A seventh aspect is the heat release structure for the vehicle of the fourth aspect, where the housing unit includes a junction block.

The heat release structure of the present invention according to the first aspect is characterized by the intake of heated air in the vicinity of the predetermined heat generator by the first end portion and the expulsion via the main portion of the heated air to the cabin interior from the second end portion being enabled when the predetermined condition is satisfied. Therefore, when the predetermined condition is satisfied, a heat releasing effect on the predetermined heat generator is realized.

Accordingly, a wire harness to be positioned running from the predetermined cabin exterior region to the cabin interior is employed as the wire harness described above. Thereby, heat can be released from the predetermined heat generator with a comparatively simple configuration where the only structural element required in practice is the heat releasing hose, the main portion of which is integrally mounted in the wire harness. As a result, dedicated heat releasing components such as a heat releasing fin or a heat releasing fan become unnecessary, and thus a heat release structure for a vehicle can be achieved with a comparatively low-cost configuration without inviting limitations on vehicle mounting.

The heat release structure of the present invention according to the second aspect enables a heat releasing effect to be realized without providing a special heated air intake ability by employing an air pressure differential arising between the cabin interior and the predetermined vehicle exterior region while the vehicle is moving.

The present invention according to the third aspect enables an effective heat releasing effect with a low-cost configuration to be realized by employing an intake hose used by a predetermined air conditioner.

The first end portion of the heat releasing hose in the present invention according to the fourth aspect is connected so as to enable airflow therethrough to the second terminus of the auxiliary hose, the first terminus of which is positioned adjacent to the predetermined heat generator. Thus, a heat releasing effect can be effectively realized for the predetermined heat generator itself provided within the housing unit.

By employing a unit connection and a wire harness connection generally included in a housing unit and a wire harness, respectively, the heat release structure in the present invention according to the fifth aspect enables an effective heat releasing effect to be realized with a comparatively simple structure and in which attachment of a first end portion to the housing unit is easy.

The present invention according to the sixth and seventh aspects enables a heat releasing effect to be realized for the predetermined heat generator housed in the housing unit such as an ECU or a junction block.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is an explanatory diagram showing a schematic configuration of a heat release structure for a vehicle, which is embodiment 1 of the present invention;

FIG. 2 is an explanatory diagram schematically showing a hose connection structure adjacent to a first end portion of a heat releasing hose;

FIG. 3 is an explanatory diagram showing details of the heat releasing hose in each of an engine compartment interior and a cabin interior, and the vicinity thereof;

FIG. 4 is an explanatory diagram schematically showing an internal structure of a housing unit, viewing the engine compartment from a direction d1;

FIG. 5 is an explanatory diagram schematically showing a connector peripheral structure in a heat release structure for a vehicle, which is embodiment 2 of the present invention;

FIG. 6 is an explanatory diagram schematically showing an air conditioning unit periphery in the cabin interior in a heat release structure for a vehicle, which is embodiment 3 of the present invention;

FIG. 7 is an explanatory diagram showing a first conventional heat release strategy;

FIG. 8 is an explanatory diagram showing a second conventional heat release strategy; and

FIG. 9 is an explanatory diagram showing a third conventional heat release strategy.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### Embodiment 1

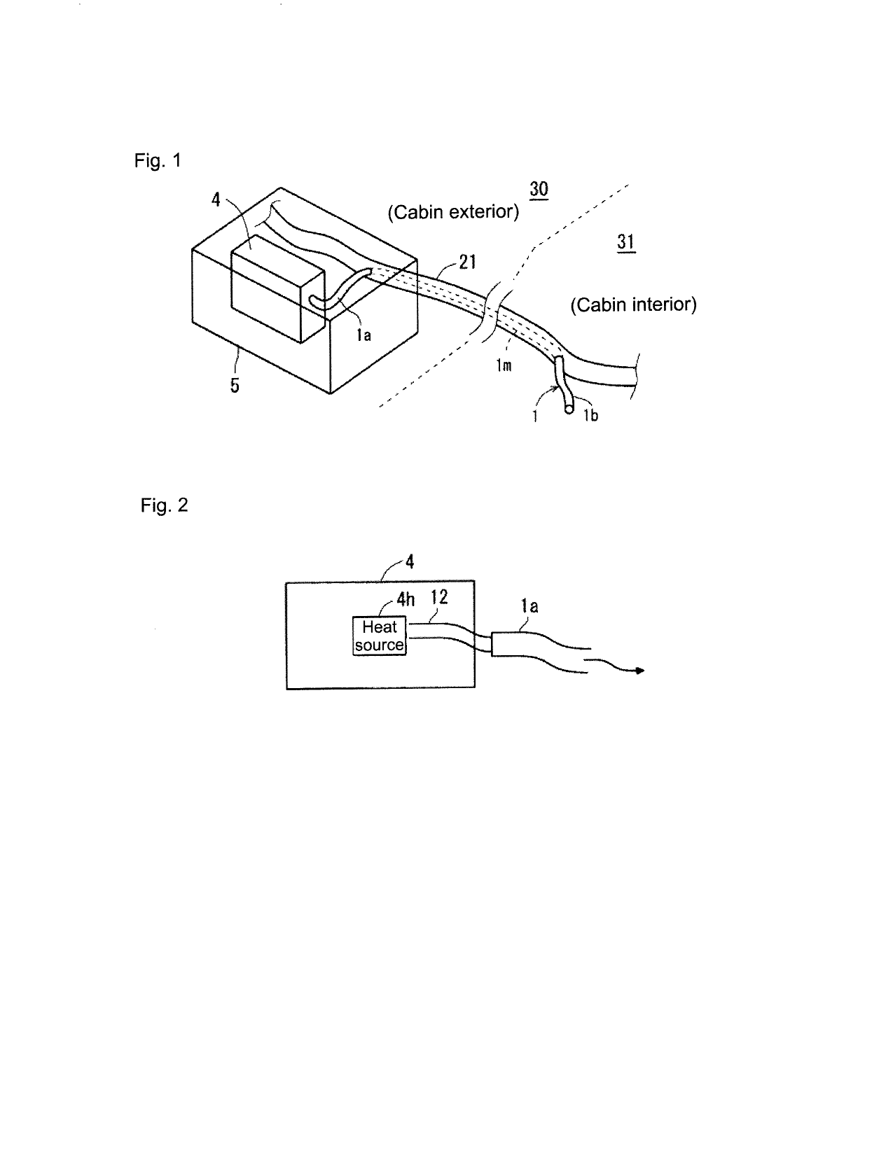

FIG. 1 is an explanatory diagram showing a schematic configuration of a heat release structure for a vehicle, which is embodiment 1 of the present invention. FIG. 2 is an explanatory diagram showing a frame view of a hose connection structure adjacent to a first end portion of a heat releasing hose.

A heat release structure for a vehicle in embodiment 1 is configured with a heat releasing hose 1 and a wire harness 21. The heat releasing hose 1 is configured with a first end portion 1a (first end portion); a main portion 1m (middle portion); and a second end portion 1b (second end portion). Moreover, in the instant specification, the first end portion 1a refers to a region of a predetermined length from a foremost end on a first side of the heat releasing hose 1 and the second end portion 1b refers to a region of a predetermined length from a foremost end on a second side of the heat releasing hose 1.

As shown in FIG. 1, the wire harness 21 is threaded from a cabin exterior 30 to a cabin interior 31. Moreover, the heat releasing hose 1 is provided by integrally mounting the main portion 1m in the wire harness 21 in any suitable manner, such as by tape winding.

A housing unit 4 is positioned within a storage box 5 on the cabin exterior 30 in an engine compartment or the like. As shown in FIG. 2, a heat generator 4h, which is a component such as a computer chip or a relay, is housed within the housing unit 4. In addition, a first terminus of an auxiliary hose 12 is positioned adjacent to the heat generator 4h and a second terminus of the auxiliary hose 12 is positioned outside the housing unit 4 through one lateral surface.

In addition, examples of the housing unit 4 include any unit which houses a component which may constitute the heat generator 4h, such as an engine control ECU, a junction block, a relay block (R/B), an antilock brake ECU, and a fuel pump resistor.

The first end portion 1a of the heat releasing hose 1 branches from the wire harness 21 within an engine compartment 10 and is connected with the second terminus of the auxiliary hose 12 provided to a lateral surface of the housing unit 4, the first end portion 1a connected such that heated air in the vicinity of the heat generator 4h can pass therethrough. Meanwhile, the second end portion 1b of the heat releasing hose 1 is positioned in a predetermined location in the cabin interior 31 (a location in the cabin interior 31 where air can be expelled).

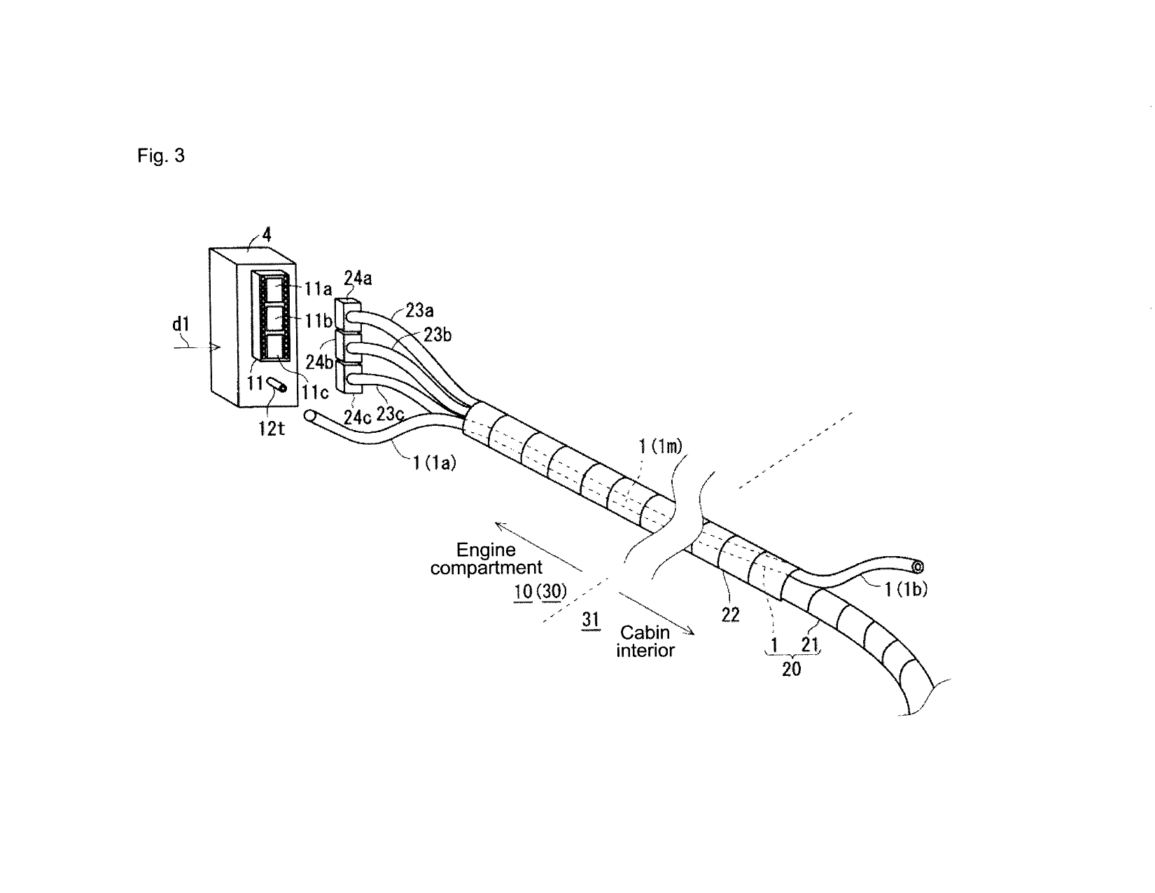

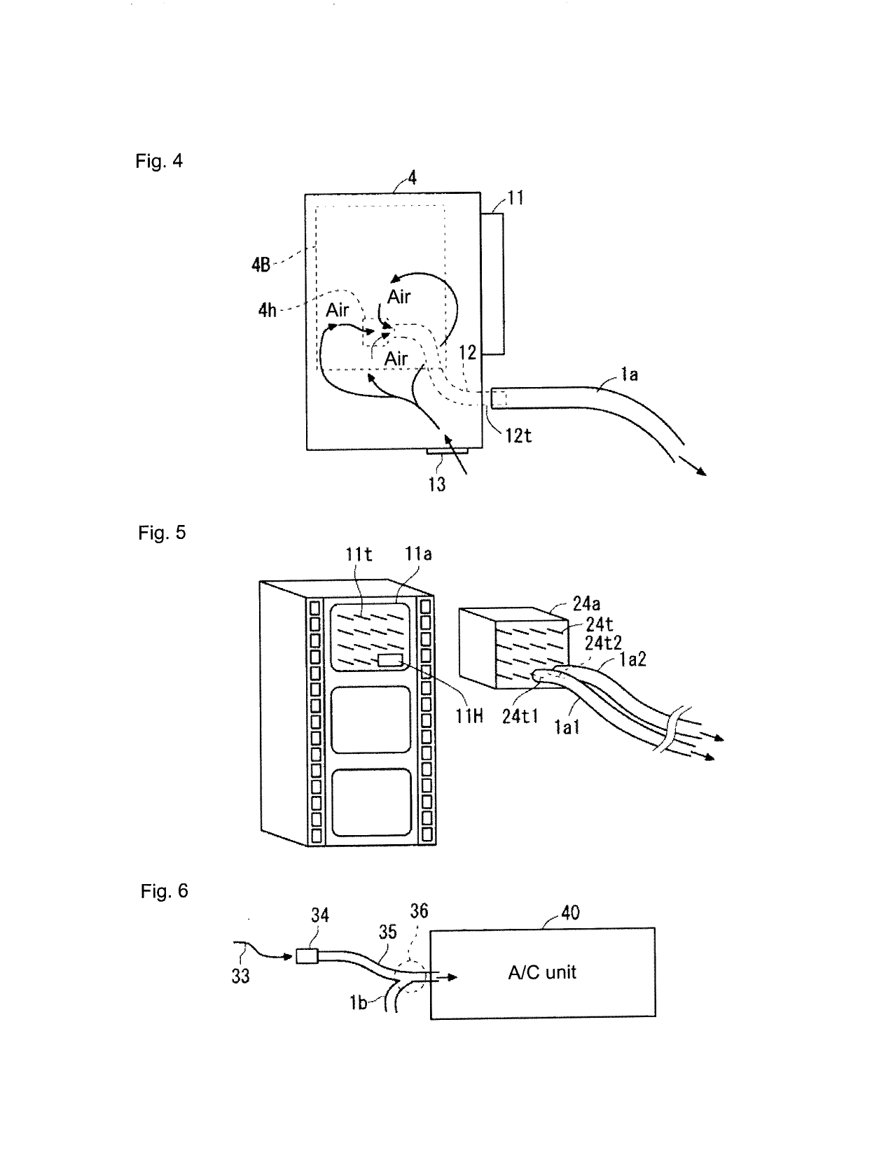

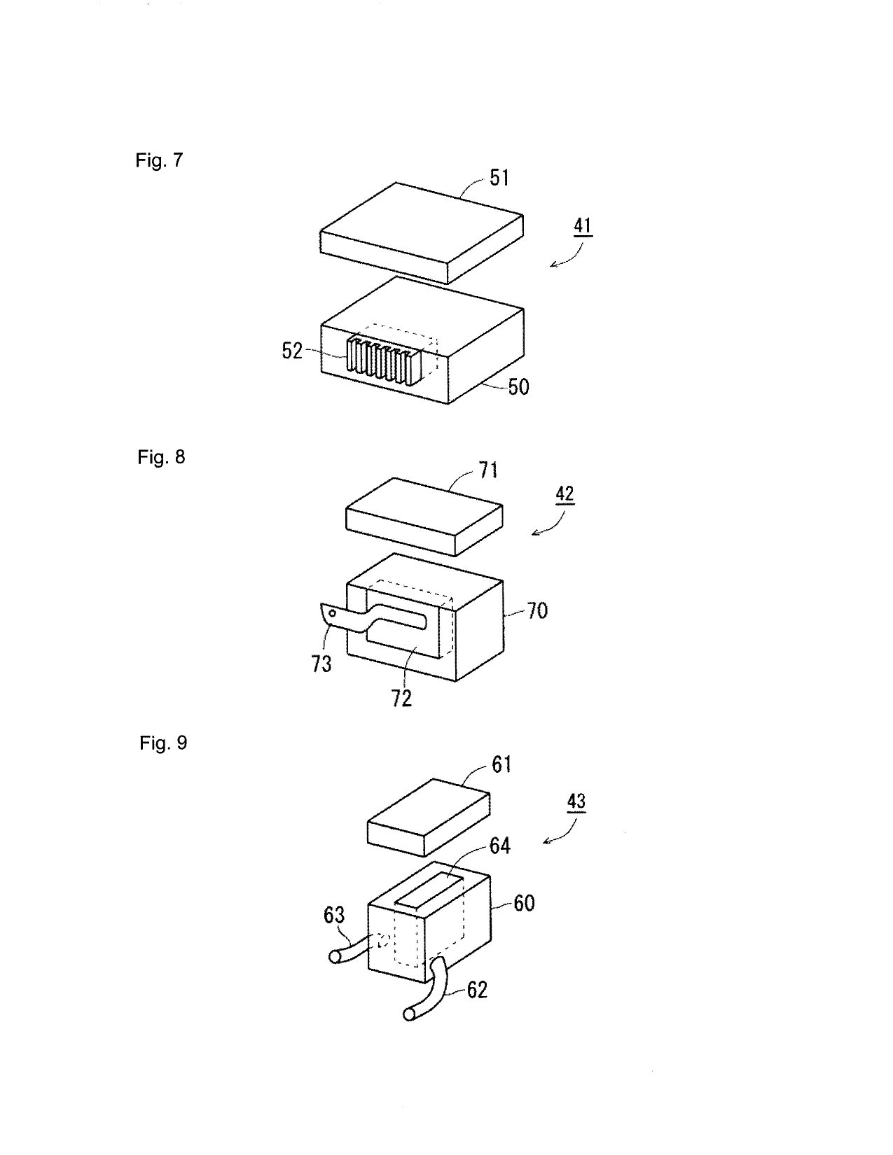

FIG. 3 is an explanatory diagram showing details of the heat releasing hose 1 in each of the engine compartment 10 interior and the cabin interior 31, and the vicinity thereof. FIG. 4 is an explanatory diagram showing a frame view of a structure, viewing the engine compartment 10 from a direction d1 in FIG. 3.

As shown in FIG. 3, the wire harness 21, in which bundles of electric wires 23a to 23c, each of which is wrapped with tape, are bundled by being further wrapped with tape, and the main portion 1m are further wrapped with a tape 22 and are thereby integrally mounted. An integrated body 20 of the heat releasing hose 1 and the wire harness 21 is provided running from the engine compartment 10 (cabin exterior 30) to the cabin interior 31.

Within the engine compartment 10, connections 24a to 24c are provided to foremost ends of the bundles of electric wires 23a to 23c exposed from the tape 22. Meanwhile, a connector 11 having connections 11a to 11c is provided to a lateral surface of the housing unit 4. By linking the connections 24a to 24c on the wire harness 21 with the connections 11a to 11c on the housing unit 4, the housing unit 4 is electrically connected to the bundles of electric wires 23a to 23c in the wire harness 21.

Moreover, within the engine compartment 10, the first end portion 1a of the heat releasing hose 1 is exposed from the tape 22 and branches from the bundles of electric wires 23a to 23c. Meanwhile, an auxiliary hose terminus 12t (the second terminus of the auxiliary hose 12) stands upright on the lateral surface of the housing unit 4. By attaching an opening on the foremost end of the first end portion 1a to the auxiliary hose terminus 12t, a path can be provided through which heated air in the vicinity of the heat generator 4h can pass from the housing unit 4 via the auxiliary hose 12 and the heat releasing hose 1 to the second end portion 1b in the cabin interior 31.

Meanwhile, in the cabin interior 31, the second end portion lb is exposed from the tape 22 and branched from the wire harness 21 into an open state, and thus is enabled to expel air into the cabin interior 31.

As shown in FIG. 4, the heat generator 4h, which is a heat generating component such as a computer chip or a relay, is mounted on a board 4B within the housing unit 4. An air vent 13 configured by adhering a waterproof vapor permeable fabric thereto is included on the housing unit 4, which is able to continuously take in air from the exterior. Moreover, the air vent 13 is provided so that the outside air and air pressure within the housing unit 4 are constant. In addition, the engine compartment 10, within which the housing unit 4 is provided, also includes a gap which is capable of continuously taking in air.

In such a configuration, while the vehicle is in motion, the cabin interior 31 becomes 0.1 to 0.3 atmospheres lower than the engine compartment 10. Therefore, the heated air in the vicinity of the heat generator 4h within the housing unit 4, which is positioned within the engine compartment 10, flows out to the cabin interior 31 from the second end portion 1b via the auxiliary hose 12 and the heat releasing hose 1. Moreover, as described above, the housing unit 4 can take air in through the outside air vent 13 and the engine compartment 10 includes a gap. Therefore, while the vehicle is moving, air continuously flows from the housing unit 4 to the cabin interior 31. Thereby, heat from the heat generator 4h within the housing unit 4 such as the ECU or the junction block can be released effectively.

In addition, the heat release structure for the vehicle of embodiment 1 takes as a predetermined condition related to the vehicle the differential air pressure arising between the cabin interior 31 and the engine compartment 10 due to the air pressure in the cabin interior 31 becoming lower than that of the engine compartment 10 (cabin exterior 30) and can realize a heat releasing effect for the heat generator 4h when the predetermined condition is satisfied. In this way, the heat release structure for the vehicle of embodiment 1 can realize a heat releasing effect without providing a separate intake ability, such as a fan, for heated air from the heat generator 4h by utilizing the air pressure differential arising between the chamber interior 31 and the engine compartment 10 that necessarily arises when the vehicle is in motion.

Moreover, the wire harness 21 is a wire harness originally intended for threading from the engine compartment 10 (the predetermined cabin exterior region) to the cabin interior 31. Therefore, the heat releasing hose 1, the main portion 1m of which is integrally mounted to the wire harness 21, and the auxiliary hose 12 are the only structural elements required in practice for the heat release structure for the vehicle.

Additionally, by employing commonly used PVC (Polyvinyl Chloride) hoses as the heat releasing hose 1 and the auxiliary hose 12, the heat releasing hose 1 and the auxiliary hose 12 may be achieved at a comparatively low cost.

When the main portion lm of the heat releasing hose 1 is mounted in the wire harness 21 used for the electrical connection to the housing unit 4, the heat release structure for the vehicle of embodiment 1 can be achieved at a basic level. Therefore, a dedicated design for the heat releasing hose 1 is unnecessary and the heat release structure for the vehicle can be designed without requiring commensurate development costs.

By altering the hose diameter of the heat releasing hose 1 as appropriate, an amount of air during heat drawing (flow of heated air from the housing unit 4 to the cabin interior 31) can be altered. Therefore, tests and analysis of heat releasing effectiveness can be performed comparatively easily, and costs required for tests and analysis can accordingly be reduced.

As a result, the heat release structure for the vehicle of embodiment 1 can release heat generated by the heat generator 4h (the predetermined heat generator) with a comparatively simple structure. In other words, dedicated heat releasing components such as a heat fin and a heat releasing fan become unnecessary, and thus the heat release structure for the vehicle can be achieved with a comparatively low-cost configuration without inviting limitations on vehicle mounting.

Additionally, as described above, dedicated heat releasing components are unnecessary, and the heat release structure for the vehicle can be obtained without relying on designs for each individual dedicated heat releasing component. Therefore, the time and effort required to rework a design when there is a change in a dedicated heat releasing component is eliminated, and thus a reduction in development costs can be achieved.

Moreover, the first end portion 1a of the heat releasing hose 1 is connected so as to enable airflow therethrough to the second terminus of the auxiliary hose 12 (auxiliary hose terminus 12t), which is an auxiliary hose in which the first terminus is positioned adjacent to the heat generator 4h. Accordingly, the heated air in the vicinity of the heat generator 4h can be taken in directly, and the heat releasing effect can be achieved that much more effectively.

Furthermore, even when a configuration does not provide an auxiliary hose 12 and simply attaches a foremost opening of the first end portion 1a to one lateral surface of the housing unit 4, air can flow continuously from the housing unit 4 to the cabin interior 31 while the vehicle is in motion. Such a configuration is thus fully capable of achieving a heat releasing effect for the heat generator 4h within the housing unit 4. However, from a perspective of greater heat releasing effect, providing the auxiliary hose 12 is preferred.

### EMBODIMENT 2

FIG. 5 is an explanatory diagram showing a frame view of connector peripheral structure of a heat release structure for a vehicle, which is embodiment 2 of the present invention.

As shown in the figure, a plurality of terminals 11t for connection with a corresponding connection 24a (connection on the wire harness) are provided on a connector 11a on the housing unit 4 side (unit connection), and an opening 11H is provided in a region where no terminal 11t is formed. Moreover, from the perspective of heat releasing effect, similar to embodiment 1, positioning the second terminus of the auxiliary hose 12 adjacent to the opening 11H on the housing unit 4 is preferred.

Meanwhile, as shown in the figure, the first end portion 1a in embodiment 2 is configured with two first end portions 1a1 and 1a2. A plurality of terminals 24t are provided on the connection 24a connected to each wire in the bundle of electric wires 23a. Of these, terminals 24t1 and 24t2 are provided not for the bundle of electric wires 23a, but for the first end portions 1a1 and 1a2.

Accordingly, when a connection is made between the corresponding connection 11a and the connection 24a, the opening 11H and the terminals 24t1 and 24t2 enter a positional relationship facing each other and, via the opening 11H and the first end portions 1a1 and 1a2, connection to the heat releasing hose 1 is made so as to enable air within the housing unit 4 to pass therethrough. Other structures are similar to the heat release structure for the vehicle of embodiment 1 shown in FIGS. 1 to 4 and a description thereof is therefore omitted. In addition, so long as a connection between the opening 11H and the first end portions 1a1 and 1a2 is possible without the terminals 24t1 and 24t2, the terminals 24t1 and 24t2 may be omitted.

In such a configuration, while the vehicle is in motion, the cabin interior 31 becomes 0.1 to 0.3 atmospheres lower than the engine compartment 10. Therefore, air within the housing unit 4 flows out to the cabin interior 31 from the second end portion 1b via the opening 11H, the first end portions 1a1 and 1a2, and the heat releasing hose 1. Accordingly, similar to embodiment 1, heat can be effectively released from the heat generator 4h within the housing unit 4 due to air flowing continuously from the housing unit 4 to the cabin interior 31 while the vehicle is in motion, achieving an effect similar to embodiment 1.

Moreover, the heat release structure for the vehicle of embodiment 2 employs the connection 24a for the bundle of electric wires 23a and the opening 11H provided to a portion of the connection 11a on the housing unit 4. Thereby, the heat releasing hose 1, the main portion 1m of which is integrally mounted to the wire harness 21, is essentially the only structural element required.

As a result, the heat release structure for the vehicle of embodiment 2 can release heat generated by the heat generator 4h (the predetermined heat generator) with a comparatively simple configuration.

Additionally, when electrically connecting the bundle of electric wires 23a to the housing unit 4, that is, connecting the connection 11a and the connection 24a, the connection of the first end portions 1a1 and 1a2 with the opening 11H can also be performed alongside. Therefore, the work of attaching the heat releasing hose 1 to the housing unit 4 can be simplified.

### EMBODIMENT 3

FIG. 6 is an explanatory diagram showing a frame view of an air conditioning unit periphery in a cabin interior 31 for a heat release structure for a vehicle, which is embodiment 3 of the present invention.

Embodiments 1 and 2 have a configuration in which the second end portion 1b of the heat releasing hose 1 is placed in a predetermined location in the cabin interior 31. However, in embodiment 3, the second end portion 1b is connected so as to flow into a sensor hose 35. This point is elaborated on below.

A cabin interior air temperature sensor 34 is provided to an air conditioning unit 40 (predetermined air conditioner). The cabin interior air temperature sensor 34 is provided at an inlet of the sensor hose 35. In order to cause the cabin interior air temperature sensor 34 to perform, cabin interior air 33 is pulled into the air conditioning unit 40 via the sensor hose 35. In other words, the air conditioning unit 40 includes a cabin interior air intake ability in which, while active, air flows continuously within the sensor hose 35 from the cabin interior air temperature sensor 34 toward the air conditioning unit 40.

Thus, the second end portion 1b of the heat releasing hose 1 is connected so as to join a hose confluence portion 36 at a middle portion of the sensor hose 35 (the intake hose). Thereby, while the air conditioning unit 40 is active, a flow of air within the heat releasing hose 1 from the first end portion 1a to the second end portion 1b can be continuously generated. Moreover, other structures are similar to the heat release structure for the vehicle of embodiment 1 shown in FIGS. 1 to 4, and therefore a description thereof is omitted. At this point, the connection between the first end portion 1a of the heat releasing hose 1 and the housing unit 4 may be carried out as in embodiment 2, shown in FIG. 5.

With such a configuration, while the air conditioning unit 40 is active, regardless of whether the vehicle is in motion, air within the housing unit 4 flows via the heat releasing hose 1 from the second end portion 1b to the air conditioning unit 40 in the cabin interior 31. Accordingly, while the air conditioning unit 40 is active, air flows continuously from the housing unit 4 to the cabin interior 31, and thus heat from the heat generator 4h within the housing unit 4 can be effectively released.

Moreover, in the heat release structure for the vehicle of embodiment 3, the heat releasing hose 1 is connected so as to join the sensor hose 35 of the air conditioning unit 40, and thus the heat releasing hose 1, the main portion 1m of which is integrally mounted to the wire harness 21, is essentially the only structural element required. In other words, embodiment 3 is a case where a predetermined condition for a vehicle capable of achieving a heat releasing effect is that the air conditioning unit 40 be active.

As a result, the heat release structure for the vehicle of embodiment 3 achieves an effect in which heat generated by the heat generator 4h (the predetermined heat generator) is released with a comparatively simple structure.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A heat release structure for a vehicle for a heat generator provided in a cabin exterior region of the vehicle, the heat release structure comprising:
a wire harness positioned so as to run from the cabin exterior region to a cabin interior; and
a heat releasing hose having a first end portion, a main portion, and a second end portion, the main portion being integrally mounted in the wire harness, wherein
the first end portion of the heat releasing hose is positioned within the cabin exterior region and the second end portion of the heat releasing hose is positioned in the cabin interior, and thereby, when a predetermined condition for the vehicle is satisfied, heated air in a vicinity of the heat generator can be taken in by the first end portion, pass through the main portion, and then be expelled to the cabin interior by the second end portion.

2. The heat release structure for the vehicle according to claim 1, wherein the predetermined condition includes an air pressure differential arising between the cabin interior and the cabin exterior region due to air pressure inside the cabin becoming lower than that of the cabin exterior region.

3. The heat release structure for the vehicle according to claim 1, wherein the cabin interior includes an air conditioned region having an air conditioner, the air conditioner having a cabin interior air intake ability taking in air of the cabin interior via an intake hose while active, and
the second end portion can be connected so as to join a middle portion of the intake hose, and
the predetermined condition includes a case where the air conditioner is active.

4. The heat release structure for the vehicle according to claim 1, wherein the heat generator comprises a heat generator housed within a housing unit, and
the heat release structure for the vehicle further comprises an auxiliary hose in which a first terminus is positioned adjacent to the heat generator inside the housing unit and a second terminus is positioned outside the housing unit, and
the first end portion is connected to the second terminus of the auxiliary hose such that heated air can flow therethrough.

5. The heat release structure for the vehicle according to claim 4, wherein
the wire harness comprises at least one bundle of electric wires,
the heat release structure for the vehicle further comprises:
a wire harness connection provided at a foremost end of the at least one bundle of electric wires; and
a unit connection provided to the housing unit and capable of linking with the wire harness connection, wherein
the unit connection includes an opening capable of expelling heated air from the heat generator,
the wire harness connection includes a heat releasing hose connection terminal capable of connecting to the first end portion of the heat releasing hose, and
when the unit connection and the wire harness connection are linked, the first end portion connected to the wire harness connection allows air within the housing unit to flow through the opening.

6. The heat release structure for the vehicle according to claim 4, wherein the housing unit comprises an ECU.

7. The heat release structure for the vehicle according to claim 4, wherein the housing unit comprises a junction block.
